(19) United States
(12) Patent Application Publication
(10) Pub. No.: US 2015/0177891 A1
(43) Pub. Date: Jun. 25, 2015

(54) WEARABLE APPARATUS SKIN INPUT

(71) Applicant: Nokia Corporation, Espoo (FI)

(72) Inventors: Leo Karkkainen, Helsinki (FI); Ari Aarnio, Espoo (FI)

(73) Assignee: Nokia Corporation, Espoo (FI)

(21) Appl. No.: 14/133,971

(22) Filed: Dec. 19, 2013

(51) Int. Cl. G06F 3/045

(52) U.S. Cl. CPC G06F 3/045; G06F 2203/04113

(57) ABSTRACT

A method comprising receiving information indicative of a first skin resistance measurement indicative of absence of skin contact between a wear surface electrode sensor and a non-wear surface electrode sensor, receiving information indicative of a second skin resistance measurement indicative of skin contact between the wear surface electrode sensor and the non-wear surface electrode sensor, and determining a user input based, at least in part, on the second skin resistance measurement is disclosed.

### TECHNICAL FIELD

The present application relates generally to wearable apparatus skin input.

### BACKGROUND

As electronic apparatuses become more prolific, the amount of activities that a user may perform with the apparatus is increasing. For example, many users interact with their apparatuses in manners that, in the past, were unassociated with an electronic apparatus. For example, many users interact with documents, media items, programs, etc., by way of their electronic apparatuses. It may be desirable to allow a user to interact with a document by way of an electronic apparatus in a simple and intuitive manner.

### SUMMARY

Various aspects of examples of the invention are set out in the claims.

One or more embodiments may provide an apparatus, a computer readable medium, a non-transitory computer readable medium, a computer program product, and a method for receiving information indicative of a first skin resistance measurement indicative of absence of skin contact between a wear surface electrode sensor and a non-wear surface electrode sensor, receiving information indicative of a second skin resistance measurement indicative of skin contact between the wear surface electrode sensor and the non-wear surface electrode sensor, and determining a user input based, at least in part, on the second skin resistance measurement.

One or more embodiments may provide an apparatus, a computer readable medium, a computer program product, and a non-transitory computer readable medium having means for receiving information indicative of a first skin resistance measurement indicative of absence of skin contact between a wear surface electrode sensor and a non-wear surface electrode sensor, means for receiving information indicative of a second skin resistance measurement indicative of skin contact between the wear surface electrode sensor and the non-wear surface electrode sensor, and means for determining a user input based, at least in part, on the second skin resistance measurement.

In at least one example embodiment, determination of the user input comprises determination that one or more skin resistance measurements, at least partially, signify the user input.

In at least one example embodiment, the wearable apparatus is an apparatus configured to be worn by the user such that the apparatus is configured to be removeably coupled to, at least part of, the user.

In at least one example embodiment, the wearable apparatus is a wrist worn apparatus.

In at least one example embodiment, the wearable apparatus is a head worn apparatus.

In at least one example embodiment, the head worn apparatus is an ocular apparatus.

In at least one example embodiment, a wear surface of the wearable apparatus is a surface that is configured to be contacted with skin of a user as a result of the wearable apparatus being worn by the user.

In at least one example embodiment, a non-wear surface of the wearable apparatus is a surface that is configured to avoid being contacted with skin of the user as a result of the wearable apparatus being worn by the user.

One or more example embodiments further perform an operation based, at least in part, on the user input.

In at least one example embodiment, the user input is an outward movement input and the operation is a volume increase operation.

In at least one example embodiment, the outward movement input is a single finger outward movement input.

In at least one example embodiment, the user input is an inward movement input and the operation is a volume decrease operation.

In at least one example embodiment, the inward movement input is a single finger inward movement input.

In at least one example embodiment, the user input is double tap input and the operation is a selection operation.

In at least one example embodiment, the user input is an outward movement input and the operation is a panning operation.

In at least one example embodiment, the outward movement input is a dual finger outward movement input.

In at least one example embodiment, the panning operation is a downward panning operation.

In at least one example embodiment, the user input is an inward movement input and the operation is a panning operation.

In at least one example embodiment, the inward movement input is a dual finger inward movement input.

In at least one example embodiment, the panning operation is an upward panning operation.

In at least one example embodiment, the input is an inward outward movement input and the operation is a selection operation.

In at least one example embodiment, the inward outward movement input comprises an inward movement prior to an outward movement.

In at least one example embodiment, the input is an outward inward movement input and the operation is a mode change operation.

In at least one example embodiment, the outward inward movement input comprises an outward movement prior to an inward movement.

In at least one example embodiment, determination of the user input is further based, at least in part, on the first skin resistance measurement.

One or more example embodiments further perform determination that the first skin resistance measurement is indicative of absence of skin contact between the wear surface electrode sensor and the non-wear surface electrode sensor.

In at least one example embodiment, the determination of the user input is based, at least in part, on the determination that the first skin resistance measurement is indicative of absence of skin contact between the wear surface electrode sensor and the non-wear surface electrode sensor.

One or more example embodiments further perform determination that the second skin resistance measurement is indicative of skin contact between the wear surface electrode sensor and the non-wear surface electrode sensor.

In at least one example embodiment, the determination of the user input is based, at least in part, on the determination that the second skin resistance measurement is indicative of skin contact between the wear surface electrode sensor and the non-wear surface electrode sensor.

One or more example embodiments further perform receipt of information indicative of a third skin resistance measurement indicative of skin resistance between the wear surface electrode sensor and the non-wear surface electrode sensor, the third skin resistance measurement being different from the second skin resistance measurement.

In at least one example embodiment, the third skin resistance measurement is indicative of absence of skin contact between a wear surface electrode sensor and a non-wear surface electrode sensor, wherein the user input is a tap input, and the determination of the tap input is further based, at least in part, on the third skin resistance measurement.

One or more example embodiments further perform determination that the third skin resistance measurement is indicative of absence of skin contact between a wear surface electrode sensor and a non-wear surface electrode sensor, wherein the determination of the tap input is further based, at least in part, on the determination that the third skin resistance measurement is indicative of absence of skin contact between a wear surface electrode sensor and a non-wear surface electrode sensor.

One or more example embodiments further perform receipt of information indicative of a fourth skin resistance measurement indicative of skin contact between the wear surface electrode sensor and the non-wear surface electrode sensor, and receipt of information indicative of a fifth skin resistance measurement indicative of absence of skin contact between the wear surface electrode sensor and the non-wear surface electrode sensor, wherein the tap input is a double tap input.

One or more example embodiments further perform determination that the fourth skin resistance measurement is indicative of absence of skin contact between a wear surface electrode sensor and a non-wear surface electrode sensor, and determination that the fifth skin resistance measurement is indicative of absence of skin contact between a wear surface electrode sensor and a non-wear surface electrode sensor, wherein the determination of the double tap input is further based, at least in part, on the determination that the fourth skin resistance measurement is indicative of absence of skin contact between a wear surface electrode sensor and a non-wear surface electrode sensor and the determination that the fifth skin resistance measurement is indicative of absence of skin contact between a wear surface electrode sensor and a non-wear surface electrode sensor.

One or more example embodiments further perform determination that the fourth skin resistance measurement was received within a double tap threshold duration from receipt of the third skin resistance measurement, wherein determination of the double tap input is based, at least in part, on the determination that the fourth skin resistance measurement was received within a double tap threshold duration from receipt of the third skin resistance measurement.

In at least one example embodiment, the third skin resistance measurement is indicative of a greater skin resistance than the skin resistance indicated by the second skin resistance measurement, wherein the user input is an outward movement input, and the determination of the outward movement input is further based, at least in part, on the third skin resistance measurement.

One or more example embodiments further perform determination that the third skin resistance measurement is indicative of a greater skin resistance than the skin resistance indicated by the second skin resistance measurement, wherein the determination of the outward movement input is further based, at least in part, on the determination that the third skin resistance measurement is indicative of a greater skin resistance than the skin resistance indicated by the second skin resistance measurement.

In at least one example embodiment, the third skin resistance measurement is indicative of a lesser skin resistance than the skin resistance indicated by the second skin resistance measurement, wherein the user input is an inward movement input, and the determination of the inward movement input is further based, at least in part, on the third skin resistance measurement.

One or more example embodiments further perform determination that the third skin resistance measurement is indicative of a lesser skin resistance than the skin resistance indicated by the second skin resistance measurement, wherein the determination of the inward movement input is further based, at least in part, on the determination that the third skin resistance measurement is indicative of a lesser skin resistance than the skin resistance indicated by the second skin resistance measurement.

One or more example embodiments further perform determination that the second skin resistance measurement is within a designated resistance range, wherein the determination of the user input is based, at least in part, on the determination that the second skin resistance measurement is within the designated resistance range.

In at least one example embodiment, the designated resistance range is a range of skin resistance measurements that is indicative of a finger contacting the skin at a designated distance.

In at least one example embodiment, the designated resistance range is a range of skin resistance measurements that is indicative of a number of fingers contacting the skin.

In at least one example embodiment, the designated resistance range is associated with a designated interface element.

One or more example embodiments further perform performance of an operation in conformance with the actuation input of the interface element.

In at least one example embodiment, the interface element is a program icon, and the operation is launching of a program indicated by the program icon.

In at least one example embodiment, the interface element is a menu item, and the operation is selection of the menu item.

One or more example embodiments further perform receipt of information indicative of a calibration skin resistance measurement, and setting the designated resistance range based, at least in part, on the calibration skin resistance measurement.

One or more example embodiments further perform causation of display of a calibration input request.

In at least one example embodiment, the designated resistance range is a range of skin resistance measurements that is indicative of a finger contacting the skin at a designated distance, and the calibration input request identifies the designated distance.

In at least one example embodiment, the designated resistance range is a range of skin resistance measurements that is indicative of a designated number of fingers contacting the skin, and the calibration input request identifies the designated number of fingers.

In at least one example embodiment, the designated resistance range is based, at least in part, on a tolerance range that surrounds a value indicated by the skin resistance measurement.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIGS. 2A-2B are diagrams illustrating wearable apparatuses according to at least one example embodiment;

FIG. 3 is a diagram illustrating skin resistance measurement according to at least one example embodiment;

FIGS. 4A-4D are diagrams illustrating user input according to at least one example embodiment;

FIGS. 5A-5C are diagrams illustrating interaction regarding a distance according to at least one example embodiment;

FIG. 6 is a diagram illustrating multiple finger input according to at least one example embodiment;

FIG. 7 is a flow diagram illustrating activities associated with determination of a user input based, at least in part, on skin resistance measurement according to at least one example embodiment;

FIG. 8 is a flow diagram illustrating activities associated with determination of a user input based, at least in part, on skin resistance measurement according to at least one example embodiment;

FIG. 9 is a flow diagram illustrating activities associated with determination of a user input based, at least in part, on skin resistance measurement according to at least one example embodiment;

FIG. 10 is a flow diagram illustrating activities associated with determination of a user input based, at least in part, on skin resistance measurement according to at least one example embodiment;

FIG. 11 is a flow diagram illustrating activities associated with determination of a user input based, at least in part, on skin resistance measurement according to at least one example embodiment;

FIG. 12 is a flow diagram illustrating activities associated with determination of a user input based, at least in part, on skin resistance measurement according to at least one example embodiment;

FIG. 13 is a flow diagram illustrating activities associated with determination of a user input based, at least in part, on skin resistance measurement according to at least one example embodiment; and

FIG. 14 is a flow diagram illustrating activities associated with determination of a user input based, at least in part, on skin resistance measurement according to at least one example embodiment.

### DETAILED DESCRIPTION OF THE DRAWINGS

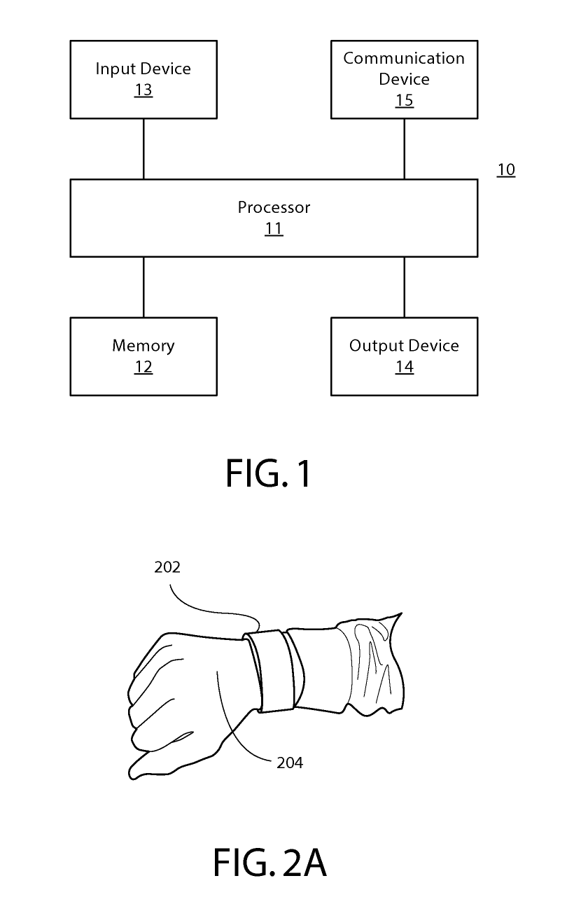

An embodiment of the invention and its potential advantages are understood by referring to FIGS. 1 through 14 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a wearable apparatus, a wrist worn apparatus, a watch apparatus, a head worn apparatus, a head mounted apparatus, a global positioning system (GPS) apparatus, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15.

In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

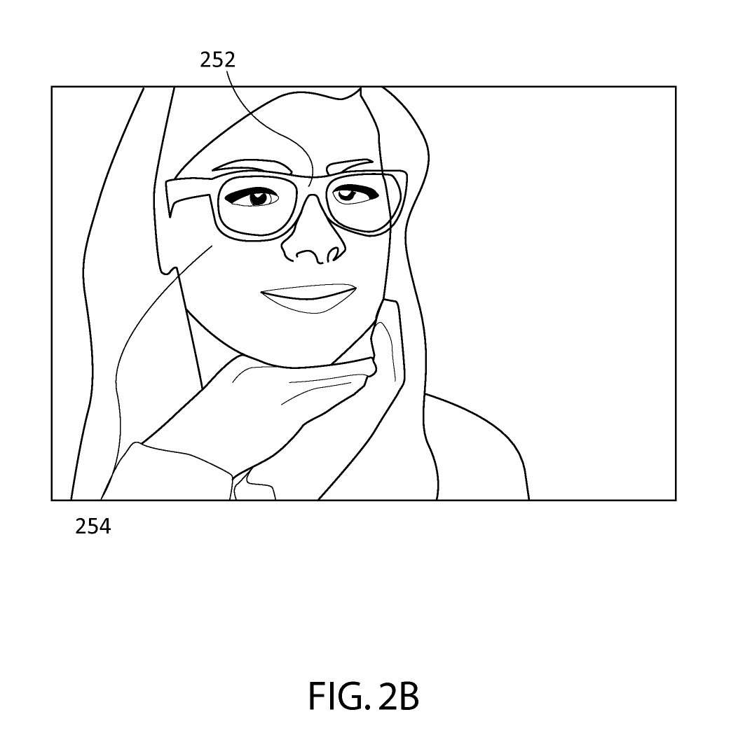

FIGS. 2A-2B are diagrams illustrating wearable apparatuses according to at least one example embodiment. The examples of FIGS. 2A-2B are merely examples and do not limit the scope of the claims. For example, configuration of the wearable apparatus may vary, part of the user for which the wearable apparatus is configured to be worn may vary, manner in which the wearable apparatus is configured to be worn may vary, and/or the like.

As users have become more reliant upon their electronic apparatuses, the roles that electronic apparatuses play in the lives of their users have increased. In many circumstances, users may desire to continually utilize their electronic apparatuses. In this manner, many users may desire their apparatus to be a wearable apparatus. For example, the user may desire to utilize the apparatus, and keep the apparatus with them, without necessarily holding the apparatus.

In at least one example embodiment, a wearable apparatus is an apparatus configured to be worn by the user. For example, the wearable apparatus may be worn by the user without the user grasping the apparatus. In at least one example embodiment, the wearable apparatus is configured to be removeably coupled to, at least part of, the user. The wearable apparatus may take the form of various types of adornments that a user may wear, such as a necklace, a ring, a watch, a headband, a bracelet, a broach, glasses, and/or the like. Likewise, the wearable apparatus may be configured to be worn on various body parts of the user, such as the head, face, neck torso, arm, wrist, hand, leg, foot, and/or the like.

FIG. 2A is a diagram illustrating a wrist worn apparatus according to at least one example embodiment. It can be seen that wrist worn apparatus 202 is configured to be worn on the wrist of a user. In this manner, wrist worn apparatus 202 is in contact with skin 204 of the user's wrist.

FIG. 2B is a diagram illustrating a head worn apparatus according to at least one example embodiment. In at least one example embodiment, a head worn apparatus is a wearable apparatus that is configured to be worn on the head of a user, such as the face of the user, the ear of the user, the forehead of the user, and/or the like. In at least one example embodiment, the head worn apparatus is an ocular apparatus, such as glasses, a visor, a monocle, a head mounted display, and/or the like. It can be seen that head worn apparatus 252 is configured to be worn on the head of a user. In this manner, head worn apparatus 252 is in contact with skin 254 of the user's head.

The wearable apparatus may be configured to sustain its position on the user by way of contacting the skin of the user. For example, the apparatus may be configured such that, when worn, the weight of the wearable apparatus is transferred into the body of the user. In this manner, there may be various surfaces of the wearable apparatus with respect to the user. In at least one example embodiment, the wearable apparatus comprises at least one wear surface and at least one non-wear surface.

In at least one example embodiment, a wear surface of the wearable apparatus is, at least part of, a surface that is configured to be contacted with skin of a user as a result of the wearable apparatus being worn by the user. For example, the wear surface of the wearable apparatus may be part of a surface that contacts the skin of the user when worn by the user in conformance with the structural design of the apparatus. For example, it can be seen that wrist worn apparatus 202 is configured such that the inward part of the curvature of the wrist adherence portion is in contact with skin 204. In this manner, the inward part of the curvature of the wrist adherence portion of wrist worn apparatus 202 is a wear surface of wrist worn apparatus 202. Similarly, it can be seen that head worn apparatus 252 is configured such that the inward part of the stems that extend from the frontal frame to the ears of the user contact with skin 254 of the user's face. In addition, it can be seen that head worn apparatus 252 is configured such that the downward rear part of the stems that extend from the frontal frame to the ears of the user contact with skin 254 on the user's ear. Furthermore, it can be seen that head worn apparatus 252 is configured such that the center of the frontal frame contact with skin 254 on the bridge of the user's nose. In this manner, any or all of these surfaces, or any parts thereof, of head worn apparatus 252 is a wear surface of wrist worn apparatus 252.

In at least one example embodiment, a non-wear surface of the wearable apparatus is a surface that is configured to avoid being contacted with skin of the user as a result of the wearable apparatus being worn by the user. For example, the non-wear surface of the wearable apparatus may be part of a surface that fails to contact the skin of the user when worn by the user in conformance with the structural design of the apparatus. For example, it can be seen that wrist worn apparatus 202 is configured such that the outward part of the curvature of the wrist adherence portion fails to contact with skin 204. In this manner, the outward part of the curvature of the wrist adherence portion of wrist worn apparatus 202 is a non-wear surface of wrist worn apparatus 202. Similarly, it can be seen that head worn apparatus 252 is configured such that the outward part of the stems that extend from the frontal frame to the ears of the user fail to contact with skin 254. In addition, it can be seen that head worn apparatus 252 is configured such that the front of the frontal frame fails to contact with skin 254. In this manner, any or all of these surfaces, or any parts thereof, of head worn apparatus 252 is a non-wear surface of wrist worn apparatus 252.

In some circumstances, it may be desirable for a wearable apparatus to be in communication with a different apparatus. The communication may be by way of a communication device, such as communication device 15. For example, the wearable apparatus may be in communication with a different wearable apparatus. In such an example, a user may be wearing a plurality of wearable apparatuses that are in communication with each other. For example, the user may be wearing a wrist worn apparatus and a head worn apparatus. In such an example the wrist worn apparatus and the head worn apparatus may be in communication with each other. In at least one example embodiment, the wearable apparatus may communication information indicative of an input to a separate apparatus, such as another wearable apparatus. For example, a wrist worn apparatus may communicate information indicative of an input received by the wrist worn apparatus to a separate apparatus. In such an example the separate apparatus may treat such received information as an input, as a part of an input, and/or the like. Similarly, a wearable apparatus may be in communication with a different wearable apparatus that is worn by a different user.

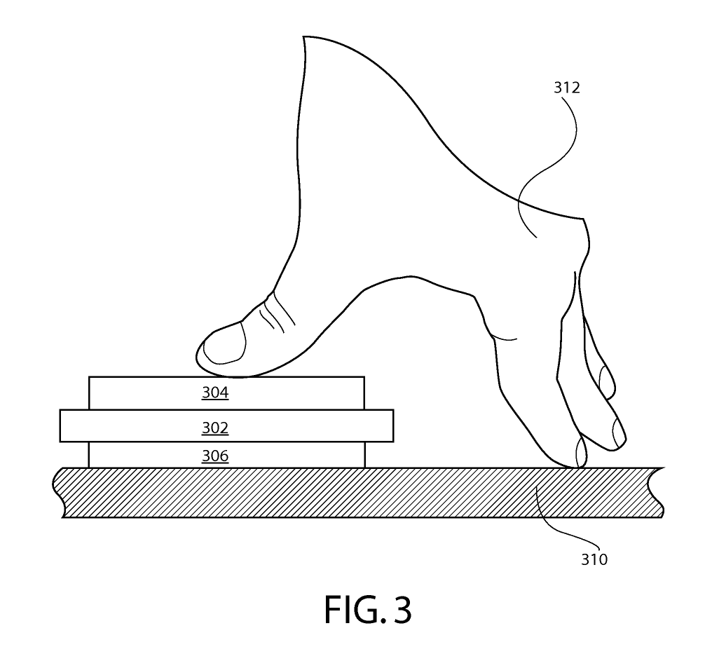

FIG. 3 is a diagram illustrating skin resistance measurement according to at least one example embodiment. The example of FIG. 3 is merely an example and does not limit the scope of the claims. For example, size of described elements may vary, orientation of the apparatus may vary, and/or the like. It should be understood that the elements illustrated in FIG. 3 are drawn out of proportion to illustrate relative positioning of the elements in at least one example embodiment. For example, in at least one example embodiment, electrode sensors 304 and 306 may be substantially thinner than wearable apparatus 302, substantially narrower than wearable apparatus 302, and/or the like. Even though the example of FIG. 3 illustrates electrode sensors as being separated, in some circumstances, electrode sensors may be merged such that a single sensor may comprises a plurality of electrode sensors. In this manner, such a sensor may comprise two electrode sensors that face in opposite directions from each other.

In many circumstances, user may desire wearable apparatuses to be small and/or light. For example, the users may desire a wrist worn apparatus to have a size and/or weight similar to a watch or a bracelet. In another example, the users may desire a head worn apparatus to have a size and/or weight similar to glasses. However, as users have become more accustomed to interacting with their apparatuses, users have increased their expectations regarding interface with their apparatuses. For example, many users may desire to have a larger surface to utilize when interacting with their apparatus. For example, a user may find a non-wear surface of a wearable apparatus to be insufficiently sized to suite some of the interactions that the user would like to perform. In such an example, there may be some interactions that the user may be comfortable performing on a non-wear surface of the wearable apparatus, but the user may desire a larger surface for other interactions. In at least one example embodiment, the wearable apparatus is configured to allow a user to perform input by way of touching skin of the user that is proximate to the wearable apparatus. In this manner, the skin of the user may be utilized as an interface surface for the wearable apparatus, even though the skin of the user is not a part of the wearable apparatus. In at least one example embodiment, the wearable apparatus utilizes skin resistance measurements to determine one or more user inputs.

There are various existing manners in which an apparatus may determine skin resistance, and there may be many manners that are developed in the future. Therefore, the manner in which skin resistance is determined does not necessarily limit the scope of the claims in any way. In at least one example embodiment, the apparatus determines a skin resistance measurement between two electrode sensors. In at least one example embodiment, an electrode sensor is a conductive material configured such that, when in contact with the skin, is capable of receiving electrical stimulus from the skin and/or sending electrical stimulus to the skin. The apparatus may receive information indicative of a skin resistance measurement by way of the electrode sensors. For example, the apparatus may receive voltage information, current information, and/or the like by way of the electrode sensors. In this manner, the apparatus may utilize the electrode sensors to determine a skin resistance measurement, for example by way of measuring galvanic skin response (GSR), electrodermal response (EDR), psychogalvanic reflex (PGR), skin conductance response (SCR), skin conductance level (SCL), and/or the like. Even though various manners of determining skin resistance may refer to skin conductance, it should be understood that skin conductivity is inversely proportional to skin resistance. In at least one example embodiment, the apparatus receives information indicative of skin resistance between two or more electrode sensors.

In order to facilitate the wearable apparatus in evaluating the user touching various parts of the skin proximate to the wearable apparatus, it may be desirable to measure the skin resistance through the skin that is proximate to the wearable apparatus and the skin of the hand that is touching the skin when the user performs the input. In this manner, it may be desirable to determine the skin resistance by way of an electrode sensor that is in contact with the skin proximate to the wearable apparatus and another electrode sensor that is in contact with the skin of the user's hand that is touching the skin proximate to the wearable apparatus when the user performs the input. In at least one example embodiment, the wearable apparatus comprises a wear surface electrode sensor that is in contact with the skin that is proximate to the wearable apparatus when the wearable apparatus is worn. In at least one example embodiment, a wear surface electrode sensor is an electrode sensor that has at least one conductive surface that corresponds with at least part of a wear surface of the wearable apparatus. For example, wrist worn apparatus 202 may comprise a wear surface electrode on the inward part of the curvature of the wrist adherence portion of wrist worn apparatus 202. Similarly, head worn apparatus 252 may comprise a wear surface electrode on that the inward part of a stem that extends from the frontal frame of head worn apparatus 252 to the ear of the user.

It may be desirable to avoid inadvertent contact with the electrode sensor that is configured to be in contact with the skin of the user's hand that is touching the skin proximate to the wearable apparatus when the user performs the input. For example, it may be desirable to avoid circumstances where such an electrode sensor contacts the skin of the user that is proximate to the wearable apparatus. In at least one example embodiment, the wearable apparatus comprises a non-wear surface electrode sensor that fails to contact with the skin that is proximate to the wearable apparatus when the wearable apparatus is worn in conformance with its physical design. In at least one example embodiment, a non-wear surface electrode sensor is an electrode sensor that has at least one conductive surface that corresponds with at least part of a non-wear surface of the wearable apparatus. For example, wrist worn apparatus 202 may comprise a non-wear surface electrode on the outward part of the curvature of the wrist adherence portion of wrist worn apparatus 202. Similarly, head worn apparatus 252 may comprise a non-wear surface electrode on that the outward part of a stem that extends from the frontal frame of head worn apparatus 252 to the ear of the user. In this manner, when wearing the wearable apparatus, a user may perform a user input by way of placing a finger on the non-wear surface electrode sensor and placing another finger on skin that is proximate to the wearable apparatus. In this manner the wearable apparatus may determine skin resistance of the skin from the finger of the user that is in contact with the non-wear surface electrode sensor, to the tip of the finger that is in contact with the skin proximate to the wearable apparatus, and to the wear surface electrode sensor. In at least one example embodiment, a wearable apparatus receives information indicative of a skin resistance measurement between the wear surface electrode sensor and the non-wear surface electrode sensor. In at least one example embodiment, the skin resistance measurement is indicative of skin resistance between the wear surface electrode sensor and the non-wear surface electrode sensor.

The example of FIG. 3 illustrates wearable apparatus 302, which comprises wear surface electrode sensor 306 and non-wear surface electrode sensor 304. In the example of FIG. 3, wearable apparatus 302 is being worn such that wear surface electrode sensor 306 is in contact with skin 310, which is skin that is proximate to wearable apparatus 302. For example, wearable apparatus 302 may be a wrist worn apparatus, such as wrist worm apparatus 202 of FIG. 2A. In such an example, skin 310 may be skin of the wrist of the user proximate to wearable apparatus 302, skin of the hand of the user proximate to wearable apparatus 302, skin of the arm of the user proximate to wearable apparatus 302, and/or the like. In another example, wearable apparatus may be a head worn apparatus, such as head worn apparatus 252 of FIG. 2B. In such an example, skin 310 may be skin of the face of the user that is proximate to wearable apparatus 302. In the example of FIG. 3, a user is performing a user input by way of contacting a thumb of hand 312 to non-wear surface electrode sensor 304 and contacting a finger of hand 312 with skin 310 that is proximate to wearable apparatus 302. In this manner, wearable apparatus 302 may receive information indicative of a skin resistance measurement between wear surface electrode sensor 306 and non-wear surface electrode sensor 304. In such an example, the skin resistance measurement is indicative of the skin resistance from the thumb of hand 312 to the finger of hand 312 and from the position on skin 310 where the finger of hand 312 contacts skin 310 to the position of skin 310 in contact with wear surface electrode sensor 306.

In some circumstances, a skin resistance measurement may be indicative of absence of skin contact between a wear surface electrode sensor and a non-wear surface electrode sensor. For example, the skin resistance measurement may be a measurement that is inconstant with a contiguous path of skin between the wear surface electrode sensor and the non-wear surface electrode sensor. For example, the skin resistance measurement may exceed a skin resistance threshold. In such an example, the skin resistance threshold may be a skin resistance that is one or more orders of magnitude greater than a standard skin resistance measurement. In at least one example embodiment, the apparatus determines that a skin resistance measurement is indicative of absence of skin contact between the wear surface electrode sensor and the non-wear surface electrode sensor.

In some circumstances, a skin resistance measurement may be indicative of skin contact between the wear surface electrode sensor and the non-wear surface electrode sensor. For example, the skin resistance measurement may be a measurement that is constant with a contiguous path of skin between the wear surface electrode sensor and the non-wear surface electrode sensor. For example, the skin resistance measurement may fail to exceed the skin resistance threshold. In at least one example embodiment, the apparatus determines that the second skin resistance measurement is indicative of skin contact between the wear surface electrode sensor and the non-wear surface electrode sensor.

Even though the example of FIG. 3 illustrates a single wear surface electrode sensor and a single non-wear surface electrode sensor, there may be a plurality of wear surface electrode sensors, a plurality of non-wear surface electrode sensors, and/or the like. For example, the apparatus may comprise a plurality of non-wear surface electrode sensors that the user may be able to utilize when performing various inputs. In at least one example embodiment, the apparatus comprises a visual differentiation indicator that facilitates the user in differentiating between different non-wear surface electrode sensors. For example, the different non-wear surface electrode sensors may be identified by different colors, different textures, different visual patterns, and/or the like.

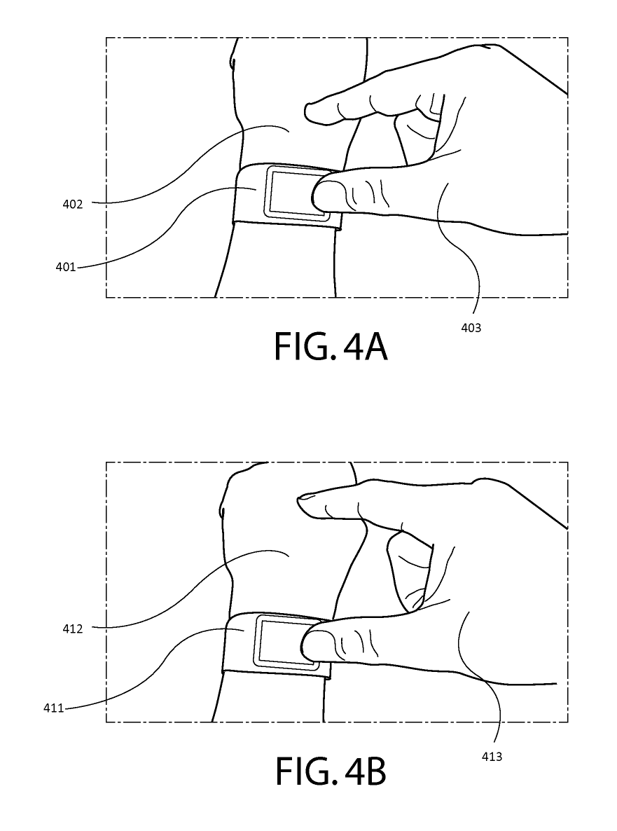

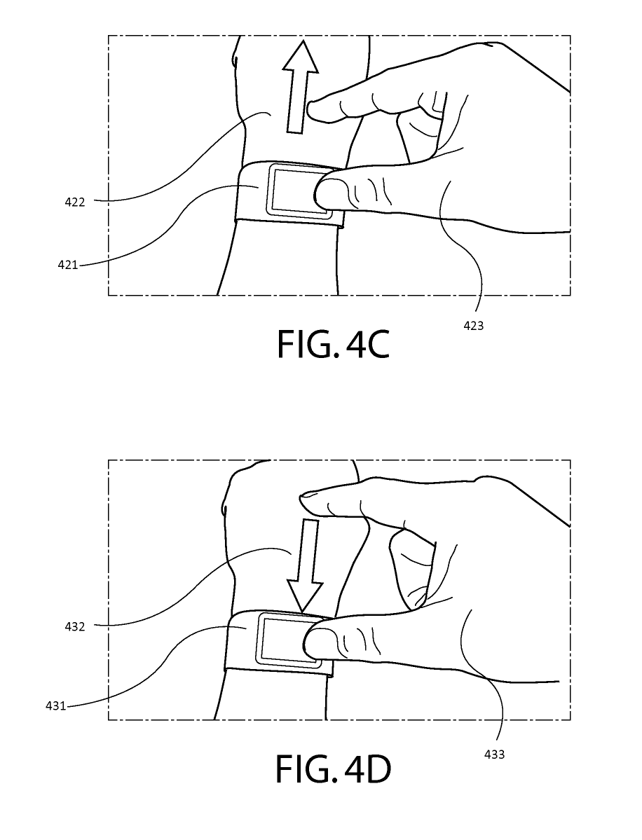

FIGS. 4A-4D are diagrams illustrating user input according to at least one example embodiment. The examples of FIGS. 4A-4D are merely examples and do not limit the scope of the claims. For example, finger placement may vary, placement of the apparatus on the user may vary, orientation of the user input may vary, type of user input may vary, and/or the like.

As previously described, in some circumstances, a user may desire to interact with a wearable apparatus by way of performance of user inputs on skin proximate to the wearable apparatus. In such circumstances, the apparatus may determine one or more user inputs based, at least in part, on skin resistance measurements, similarly as described regarding FIG. 3. In at least one example embodiment, the apparatus determines a user input based, at least in part, on the second skin resistance measurement. In at least one example embodiment, the determination of the user input comprises determination that one or more skin resistance measurements, at least partially, signify the user input. For example, the apparatus may determine that one or more skin resistance measurements identify a contact portion of a user input, a contact removal portion of a user input, a movement portion of a user input, and/or the like.

In at least one example embodiment, an input may be characterized by, at least one change from a skin resistance measurement that is indicative of absence of skin contact between electrode sensors to a skin resistance measurement that is indicative of skin contact between electrode sensors. In this manner, at least part of a user input may be characterized by introduction of skin contact between electrode sensors.

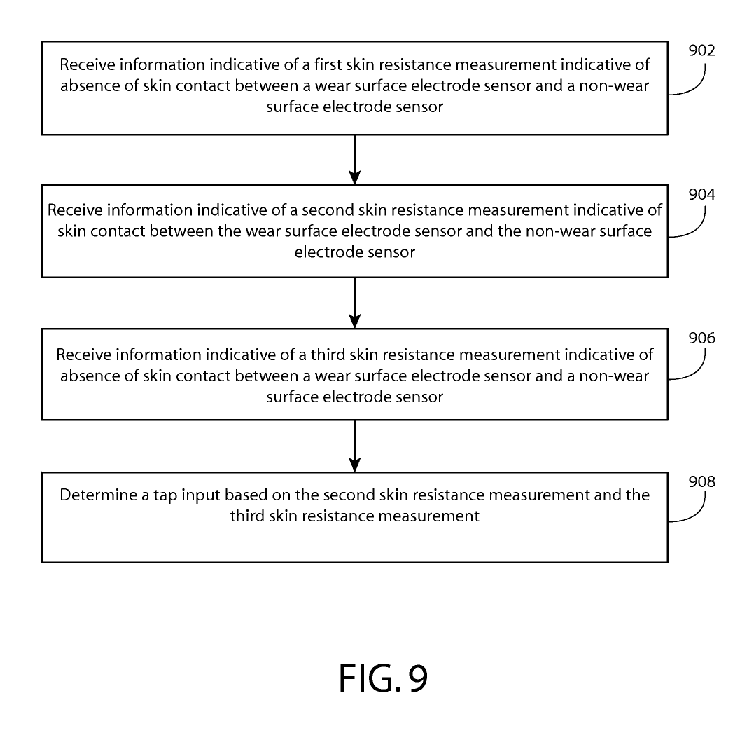

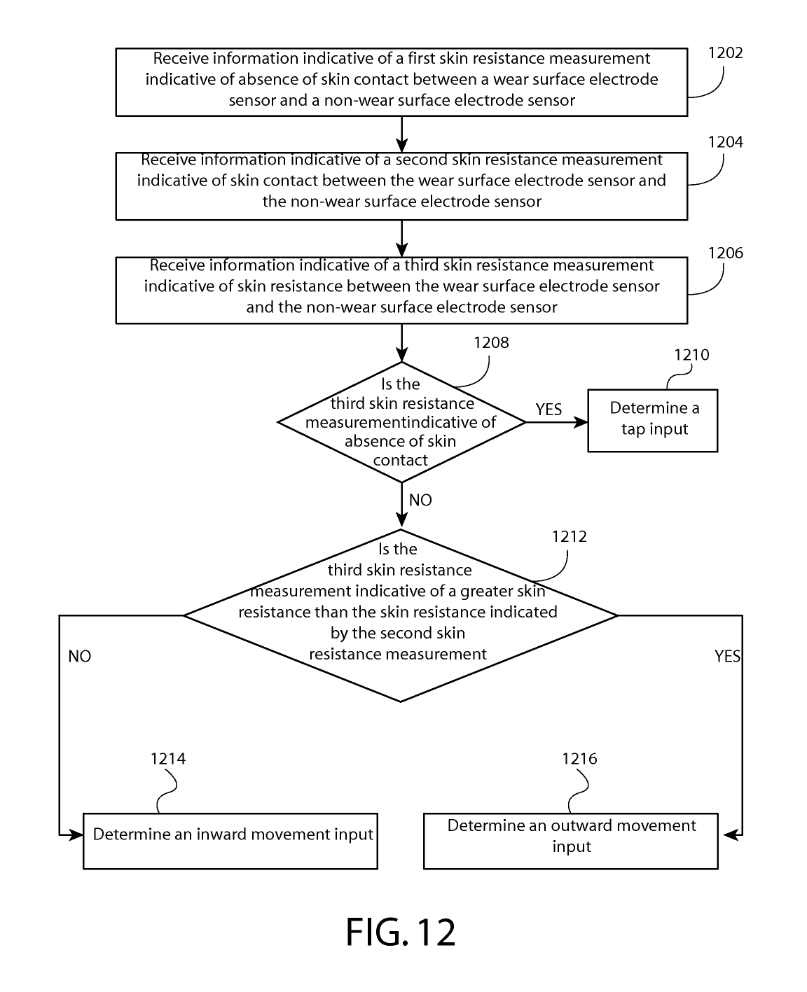

FIG. 4A is a diagram illustrating a user input according to at least one example embodiment. In the example of FIG. 4A a user is performing a user input for apparatus 401 by way of hand 403 and skin 402. It can be seen that the thumb of hand 403 is in contact with apparatus 401 and that a finger of hand 403 is in contact with skin 402. In this manner, apparatus 401 may determine a user input based, at least in part, on the skin resistance measurement between a non-wear surface electrode sensor being contacted by the thumb of hand 403 and a wear surface electrode sensor that is in contact with skin 402. For example, apparatus 401 may determine that the user input of FIG. 4A is, at least part of, a tap input, a movement input, and/or the like. The tap input may be similar as described regarding FIG. 9 and FIG. 12. The movement input may similar as described regarding FIGS. 4C-4D, FIG. 10, FIG. 11, and FIG. 12.

FIG. 4B is a diagram illustrating a user input according to at least one example embodiment. In the example of FIG. 4B, a user is performing a user input for apparatus 411 by way of hand 413 and skin 412. It can be seen that the thumb of hand 413 is in contact with apparatus 411 and that a finger of hand 413 is in contact with skin 412. In this manner, apparatus 411 may determine a user input based, at least in part, on the skin resistance measurement between a non-wear surface electrode sensor being contacted by the thumb of hand 413 and a wear surface electrode sensor that is in contact with skin 412. For example, apparatus 411 may determine that the user input of FIG. 4B is, at least part of, a tap input, a movement input, and/or the like.

In comparing the user input of FIG. 4A to the user input of FIG. 4B, it can be seen that, in FIG. 4A, the finger of hand 403 is contacting skin 402 at a distance from apparatus 401 that is less than a distance, in FIG. 4B, between the finger of hand 413 contacting skin 412 and apparatus 411. In this manner, the skin resistance measurement of the user input of FIG. 4A may be less than the skin resistance measurement of the user input of FIG. 4B. Likewise, the skin resistance measurement of the user input of FIG. 4B may be greater than the skin resistance measurement of the user input of FIG. 4A. In this manner, the skin resistance measurement of the user input of FIG. 4B may be indicative of a greater skin resistance than the skin resistance indicated by the skin resistance measurement of the user input of FIG. 4A. Similarly, the skin resistance measurement of the user input of FIG. 4A may be indicative of a lesser skin resistance than the skin resistance indicated by the skin resistance measurement of the user input of FIG. 4B.

In at least one example embodiment, an apparatus determines that a skin resistance measurement is indicative of a movement input based, at least in part, on a change in the skin resistance measurement. For example, the apparatus may receive a plurality of skin resistance measurements, and determine a movement input based, at least in part, on a change of the skin resistance measurement across the plurality of skin resistance measurements.

In at least one example embodiment, the apparatus determines that a change from a lesser skin resistance measurement to a greater skin resistance is indicative of an outward movement input. In at least one example embodiment, an outward movement input is a user input characterized by the user increasing distance between a position of skin contact of the user input and the apparatus. For example, a user performing the user input of FIG. 4A, then moving the position of the finger away from the apparatus so that the finger becomes positioned as indicated by the user input of FIG. 4B, may be performing an outward user input. In at least one example embodiment, the apparatus determines that a subsequent skin resistance measurement is indicative of a greater skin resistance than a skin resistance indicated by a prior skin resistance measurement. In at least one example embodiment, the apparatus determines an outward movement input based, at least in part, on the determination that a subsequent skin resistance measurement is indicative of a greater skin resistance than a skin resistance indicated by a prior skin resistance measurement.

FIG. 4C is a diagram illustrating an outward movement input according to at least one example embodiment. In the example of FIG. 4C a user is performing a user input for apparatus 421 by way of hand 423 and skin 422. It can be seen that the thumb of hand 423 is in contact with apparatus 421 and that a finger of hand 423 is in contact with skin 422. In this manner, apparatus 421 may determine a user input based, at least in part, on the skin resistance measurement between a non-wear surface electrode sensor being contacted by the thumb of hand 423 and a wear surface electrode sensor that is in contact with skin 422. In the example of FIG. 4C, it can be seen that the finger of hand 423 is moving away from apparatus 421 along skin 422. In this manner, the apparatus may receive information indicative of consecutive skin resistance measurements that indicate an increasing skin resistance measurement. In this manner, the apparatus may determine that the user input of FIG. 4C is an outward movement input based, at least in part, on the determination that the consecutive skin resistance measurements that indicate an increasing skin resistance measurement.

In at least one example embodiment, the apparatus determines that a change from a greater skin resistance measurement to a lesser skin resistance is indicative of an inward movement input. In at least one example embodiment, an inward movement input is a user input characterized by the user decreasing distance between a position of skin contact of the user input and the apparatus. For example, a user performing the user input of FIG. 4B, then moving the position of the finger towards the apparatus so that the finger becomes positioned as indicated by the user input of FIG. 4A, may be performing an inward user input. In at least one example embodiment, the apparatus determines that a subsequent skin resistance measurement is indicative of a lesser skin resistance than a skin resistance indicated by a prior skin resistance measurement. In at least one example embodiment, the apparatus determines an inward movement input based, at least in part, on the determination that a subsequent skin resistance measurement is indicative of a lesser skin resistance than a skin resistance indicated by a prior skin resistance measurement.

FIG. 4D is a diagram illustrating an inward movement input according to at least one example embodiment. In the example of FIG. 4D a user is performing a user input for apparatus 431 by way of hand 433 and skin 432. It can be seen that the thumb of hand 433 is in contact with apparatus 431 and that a finger of hand 433 is in contact with skin 432. In this manner, apparatus 431 may determine a user input based, at least in part, on the skin resistance measurement between a non-wear surface electrode sensor being contacted by the thumb of hand 433 and a wear surface electrode sensor that is in contact with skin 432. In the example of FIG. 4D, it can be seen that the finger of hand 433 is moving towards apparatus 431 along skin 432. In this manner, the apparatus may receive information indicative of consecutive skin resistance measurements that indicate a decreasing skin resistance measurement. In this manner, the apparatus may determine that the user input of FIG. 4D is an inward movement input based, at least in part, on the determination that the consecutive skin resistance measurements that indicate a decreasing skin resistance measurement.

In some circumstances, the user may desire to interact with the apparatus by way of a combination of movement inputs. For example, the user may desire that a combination of an outward movement input, such as the outward movement input of FIG. 4C, and a subsequent inward movement input, such as the inward movement input of FIG. 4D, be treated as a distinct input. In another example, the user may desire that a combination of an inward movement input and a subsequent outward movement input be treated as a distinct input. In at least one example embodiment, the apparatus determines that an inward movement input prior to an outward input is an inward outward movement input. In at least one example embodiment, the apparatus determines that an outward movement input prior to an inward input is an outward inward movement input.

In some circumstances, the user may desire to interact with the apparatus by way of a combination of tap inputs. For example, the user may desire that a combination of multiple consecutive tap inputs be treated as a distinct input. In at least one example embodiment, the apparatus determines that a tap input prior to another tap input is double tap input.

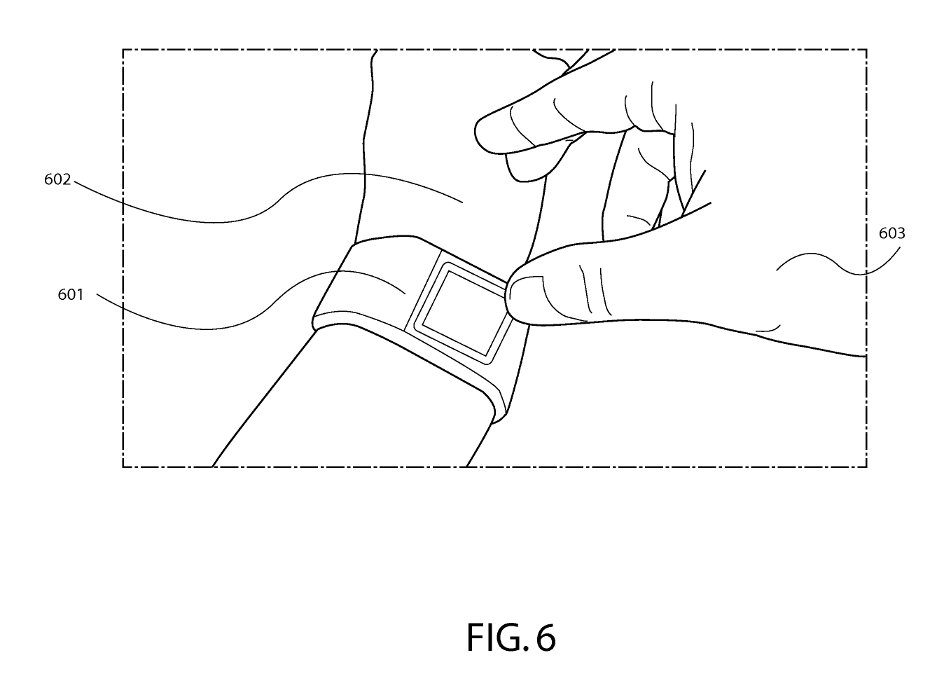

In some circumstances, the apparatus may determine the user input based, at least in part, on determination of a number of fingers that are in contact with the skin. The apparatus may determine a number of fingers in contact with the skin similarly as described regarding FIG. 6. In this manner, a user input may be a single finger input, a dual finger input, a multiple finger input, a three finger input, and/or the like. For example, the apparatus may determine that a movement input is a single finger movement input, is a dual finger movement input, a multiple finger movement input, a three finger movement input, and/or the like.

In at least one example embodiment, the apparatus performs an operation based, at least in part, on the user input. For example, the user input may cause the apparatus to perform the operation. Such an operation may comprise a volume adjustment operation, a selection operation, a panning operation, a mode change operation, launching of a program, and/or the like.

In at least one example embodiment, a volume adjustment operation is an operation that causes a change to one or more audio volume settings of the apparatus. The volume adjustment operation may be a volume increase operation, a volume decrease operation, and/or the like.

In at least one example embodiment, a selection operation is an operation that designates an interface element for an action. For example, the selection operation may identify an interface element for the apparatus to operate upon, may identify a menu item for use by the apparatus, and/or the like. The interface element may be any distinct portion of the user interface of the apparatus that may be operated upon by way of a user input. For example, an interface element may be an icon, a button, a text box, and/or the like. In such an example, if the interface element is a program icon, the selection may cause launching of a program indicated by the program icon.

In at least one example embodiment, a panning operation is an operation that causes movement of information displayed by the apparatus. For example, a panning operation may be indicative of scrolling information in a particular direction. For example, the panning operation may be an upward panning operation, a downward panning operation, a leftward panning operation, a rightward panning operation, and/or the like.

In at least one example embodiment, a mode change operation is an operation that changes an operational mode of the apparatus to a different operational mode of the apparatus. For example, an operational mode may be a particular power consumption mode, a particular interaction mode, a particular capability mode, and/or the like. For example, the apparatus may be configured to operation in a flight mode and in a non-flight mode. In such an example, the flight mode may involve the apparatus disabling particular features that may be prohibited during flight.

In at least one example embodiment, launching of a program involves causing a program to become operational on the apparatus. For example, the apparatus may initiate operation of the program, may resume operation of the program, and/or the like.

The apparatus may comprise instructions, data, and/or the like that correlates user inputs with operations. In some circumstances, there may be particular inputs that identify particular operations to be performed by the apparatus. For example, the apparatus may determine that an outward movement input correlates with a volume increase operation. In another example, the apparatus may determine that an inward movement input correlates with is a volume decrease operation. In another example, the apparatus may determine that a double tap input correlates with a selection operation. In another example, the apparatus may determine that an outward movement input correlates with a panning operation, such as a downward panning operation. In another example, the apparatus may determine that an inward movement input correlates with a panning operation such as an upward panning operation. In another example, the apparatus may determine that an inward outward movement input correlates with a selection operation. In another example, the apparatus may determine that an outward inward movement input correlates with a mode change operation.

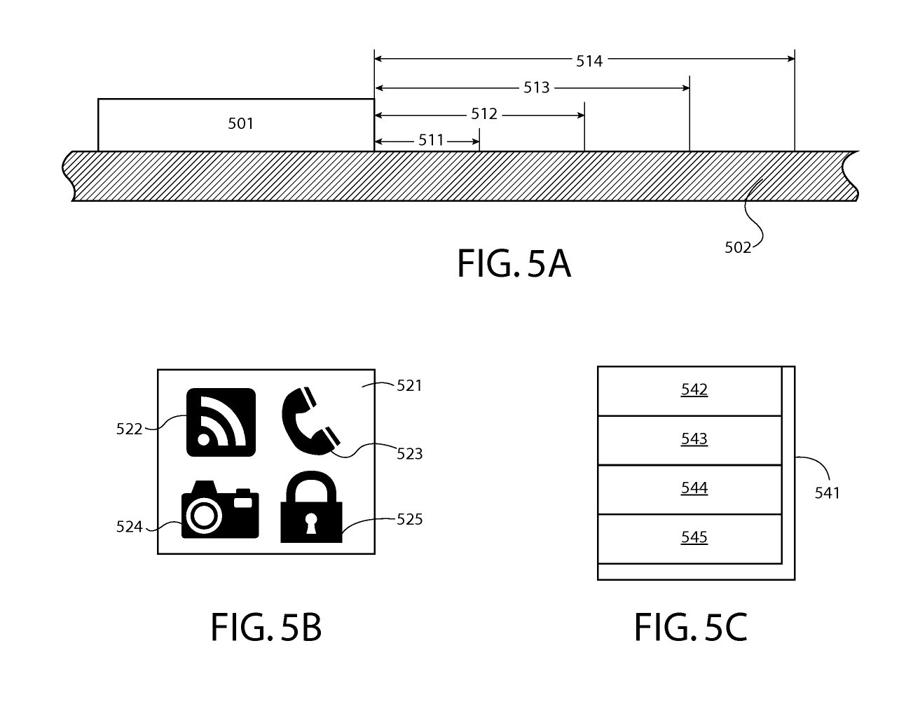

FIGS. 5A-5C are diagrams illustrating interaction regarding a distance according to at least one example embodiment. The examples of FIGS. 5A-5C are merely examples and do not limit the scope of the claims. For example, distances may vary, interrelationship between distances and interface elements may vary, configuration of interface elements may vary, and/or the like.

In some circumstances, it may be desirable to determine a user input by correlating a skin resistance measurement with a predetermined range of skin resistance measurements. For example, the apparatus may characterize a distance between an apparatus and contact of the skin between electrode sensors by way of a predetermined range of skin resistance measurements. In another example, the apparatus may characterize a number of fingers involved in contact of the skin between electrode sensors by way of a predetermined range of skin resistance measurements, similarly as described regarding FIG. 6.

In at least one example embodiment, the apparatus determines that a skin resistance measurement is within a designated resistance range. In at least one example embodiment, the determination of the user input is based, at least in part, on the determination that the skin resistance measurement is within the designated resistance range. In at least one example embodiment, the designated resistance range is a bounded set of skin resistance measurements that are indicative of a particular property of a user input, of a particular user input, and/or the like. In at least one example embodiment, the designated resistance range is a range of skin resistance measurements that is indicative of a finger contacting the skin at a designated distance. In at least one example embodiment, the apparatus comprises a set of designated resistance ranges such that each designated resistance range indicates a different distance. In this manner, the apparatus may identify a particular distance by way of correlating the skin resistance measurement with a designated resistance range that indicates the particular distance.

FIG. 5A is a diagram illustrating distance ranges according to at least one example embodiment. In the example of FIG. 5A, distance 511 indicates a particular distance from apparatus 501 along skin 502, distance 512 indicates another particular distance from apparatus 501 along skin 502, distance 513 indicates yet another particular distance from apparatus 501 along skin 502, and distance 514 indicates still another particular distance from apparatus 501 along skin 502. It can be seen that distance 512 is greater than distance 511 and less than distance 513. It can be seen that distance 513 is greater than distance 512 and less than distance 514. In at least one example embodiment, a designated resistance range indicates a finger contacting skin 502 at distance 511 from apparatus 501. In at least one example embodiment, another designated resistance range indicates a finger contacting skin 502 at distance 512 from apparatus 501. In at least one example embodiment, yet another designated resistance range indicates a finger contacting skin 502 at distance 513 from apparatus 501. In at least one example embodiment, still another designated resistance range indicates a finger contacting skin 502 at distance 514 from apparatus 501. In this manner, apparatus 501 may determine a distance of a finger contacting the skin by way of determining that the skin resistance measurement is within a particular designated resistance range. For example, the apparatus may determine that an input is a tap input at distance 511 by way of identifying that the skin resistance measurement of the tap input is within the designated resistance range associated with distance 511.

In some circumstances, the user may desire to perform an input at a particular distance from the apparatus in order to designate a particular interface item to which the input is to be applied. For example, the user may desire an input to be a menu item selection input when the user performs the input at a distance, and may desire an input to be a different menu item selection input when the user performs the input at a different distance. In at least one example embodiment, the designated resistance range is associated with a designated interface element. In such an example, the input may be characterized as being an input of the particular interface element. For example, if the interface element is a messaging program icon, the input may be a messaging program tap input, a messaging program movement input, and/or the like. In at least one example embedment, the apparatus performs an operation in conformance with the interface element. In such an example, the apparatus may perform an operation associated with the input on an object identified by the interface element.

In at least one example embodiment, the apparatus may associate a distance with an interface element based, at least in part, on spatial position of the interface element on the display. For example, the apparatus may sequentially associate interface elements with increasing distances based, at least in part, on the ordering of the interface elements of a display. For example, the apparatus may correlate distances to interface items based, at least in part, on a top to bottom ordering, a bottom to top ordering, a left to right ordering, a right to left ordering, and/or the like.

FIG. 5B is a diagram illustrating interface elements according to at least one example embodiment. The example of FIG. 5B illustrates program icons 522, 523, 524 and 525 in relation to display 521. In at least one example embodiment, apparatus 501 of FIG. 5A comprises display 521 such that apparatus 501 is displaying program icons 522, 523, 524, and 525. In the example of FIG. 5B, program icon 522 is associated with distance 511 of FIG. 5A such that a user input that corresponds with distance 511 is a user input associated with program icon 522. For example, a tap input at distance 511 may cause the apparatus to launch the program associated with program icon 522. In the example of FIG. 5B, program icon 523 is associated with distance 512 of FIG. 5A such that a user input that corresponds with distance 512 is a user input associated with program icon 523. In the example of FIG. 5B, program icon 524 is associated with distance 513 of FIG. 5A such that a user input that corresponds with distance 513 is a user input associated with program icon 524. In the example of FIG. 5B, program icon 525 is associated with distance 514 of FIG. 5A such that a user input that corresponds with distance 514 is a user input associated with program icon 525.

FIG. 5C is a diagram illustrating interface elements according to at least one example embodiment. The example of FIG. 5C illustrates menu items 542, 543, 544 and 545 in relation to display 541. In at least one example embodiment, apparatus 501 of FIG. 5A comprises display 541 such that apparatus 501 is displaying menu items 542, 543, 544, and 545. In the example of FIG. 5C, menu item 542 is associated with distance 511 of FIG. 5A such that a user input that corresponds with distance 511 is a user input associated with menu item 542. For example, a tap input at distance 511 may cause the apparatus to select menu item 542. In the example of FIG. 5B, menu item 543 is associated with distance 512 of FIG. 5A such that a user input that corresponds with distance 512 is a user input associated with menu item 543. In the example of FIG. 5B, menu item 544 is associated with distance 513 of FIG. 5A such that a user input that corresponds with distance 513 is a user input associated with menu item 544. In the example of FIG. 5B, menu item 545 is associated with distance 514 of FIG. 5A such that a user input that corresponds with distance 514 is a user input associated with menu item 545.

FIG. 6 is a diagram illustrating multiple finger input according to at least one example embodiment. The example of FIG. 6 is merely an example and does not limit the scope of the claims. For example, finger placement may vary, placement of the apparatus on the user may vary, orientation of the user input may vary, and/or the like.

As previously described, in some circumstances it may be desirable to characterize a user input based, at least in part, on the number of fingers that are contacting the skin. The number of fingers contacting the skin may affect the skin resistance measurement between to electrode sensors by way of increasing the surface area between the fingers and the contacted skin. In the example of FIG. 6, a user is performing a user input for apparatus 601 by way of hand 603 and skin 602. It can be seen that the thumb of hand 603 is in contact with apparatus 601 and that two fingers of hand 603 are in contact with skin 602. In this manner, apparatus 601 may determine a user input based, at least in part, on the skin resistance measurement between a non-wear surface electrode sensor being contacted by the thumb of hand 603 and a wear surface electrode sensor that is in contact with skin 602.

It can be seen that the two fingers of hand 603 being in contact with skin 602 is associated with a larger surface area of skin 602 beyond the surface area associated with contact of a single finger. In this manner, the increase in surface area may correspond with a lesser skin resistance measurement for a dual finger user input than a skin resistance measurement of a lesser surface area. Therefore, the apparatus may utilize a designated resistance range to identify number of fingers contacting the skin during a user input.

In at least one example embodiment, the designated resistance range is a range of skin resistance measurements that is indicative of a number of fingers contacting the skin. In at least one example embodiment, a designated resistance range is associated with a single finger user input, a different designated resistance range is associated with a dual finger user input, another designated resistance range is associated with a three finger user input, and/or the like. In this manner, the apparatus may determine a particular number of fingers associated with contact of the skin during a user input by way of determination that at least one skin resistance measurement associated with the user input corresponds with a designated resistance range that is associated with the particular number of fingers.

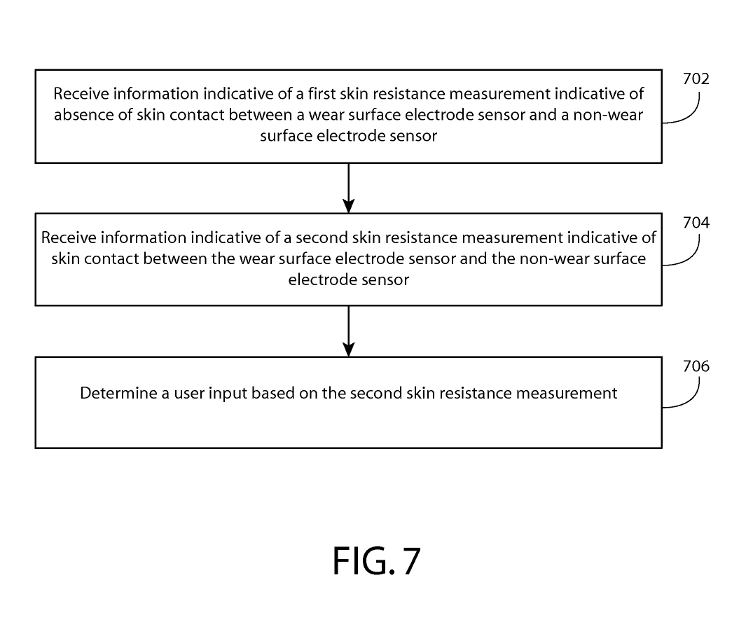

FIG. 7 is a flow diagram illustrating activities associated with determination of a user input based, at least in part, on skin resistance measurement according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

At block 702, the apparatus receives information indicative of a first skin resistance measurement indicative of absence of skin contact between a wear surface electrode sensor and a non-wear surface electrode sensor. The receipt, the first skin resistance measurement, the absence of skin contact, the wear surface electrode sensor, and the non-wear surface electrode sensor may be similar as described regarding FIG. 3, FIGS. 4A-4D, FIGS. 5A-5C, and FIG. 6.

At block 704, the apparatus receives information indicative of a second skin resistance measurement indicative of skin contact between the wear surface electrode sensor and the non-wear surface electrode sensor. The receipt, the second skin resistance measurement, and the skin contact may be similar as described regarding FIG. 3, FIGS. 4A-4D, FIGS. 5A-5C, and FIG. 6.

At block 706, the apparatus determines a user input based, at least in part, on the second skin resistance measurement. The determination and the user input may be similar as described regarding FIGS. 4A-4D, FIGS. 5A-5C, and FIG. 6.

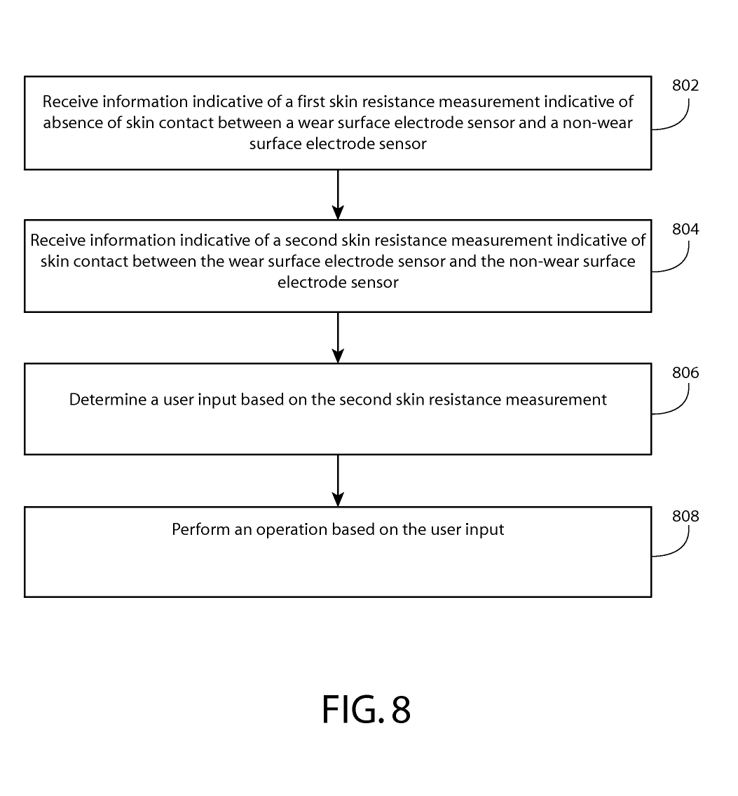

FIG. 8 is a flow diagram illustrating activities associated with determination of a user input based, at least in part, on skin resistance measurement according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As previously described, in some circumstances, it may be desirable for the apparatus to perform an operation based, at least in part, on the user input.

At block 802, the apparatus receives information indicative of a first skin resistance measurement indicative of absence of skin contact between a wear surface electrode sensor and a non-wear surface electrode sensor, similarly as described regarding block 702 of FIG. 7. At block 804, the apparatus receives information indicative of a second skin resistance measurement indicative of skin contact between the wear surface electrode sensor and the non-wear surface electrode sensor, similarly as described regarding block 704 of FIG. 7. At block 806, the apparatus determines a user input based, at least in part, on the second skin resistance measurement, similarly as described regarding block 706 of FIG. 7.

At block 808, the apparatus performs an operation based, at least in part, on the user input. The performance of the operation may be similar as described regarding FIGS. 4A-4D and FIGS. 5A-5C.

FIG. 9 is a flow diagram illustrating activities associated with determination of a user input based, at least in part, on skin resistance measurement according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As previously described, it may be desirable for a user to perform a tap input. In at least one example embodiment, a tap input is an input characterized by the user forming contact with the skin and releasing contact with the skin. In at least one example embodiment, the tap input fails to comprise a movement input between the contact with the skin and the release of contact with the skin. In at least one example embodiment, formation of contact with the skin is characterized by absence of contact with the skin followed by contact with the skin.

At block 902, the apparatus receives information indicative of a first skin resistance measurement indicative of absence of skin contact between a wear surface electrode sensor and a non-wear surface electrode sensor, similarly as described regarding block 702 of FIG. 7. At block 904, the apparatus receives information indicative of a second skin resistance measurement indicative of skin contact between the wear surface electrode sensor and the non-wear surface electrode sensor, similarly as described regarding block 704 of FIG. 7.

At block 906, the apparatus receives information indicative of a third skin resistance measurement indicative of indicative of absence of skin contact between the wear surface electrode sensor and the non-wear surface electrode sensor, the third skin resistance measurement being different from the second skin resistance measurement. The receipt and the third skin resistance measurement may be similar as described regarding FIG. 3, FIGS. 4A-4D, FIGS. 5A-5C, and FIG. 6.

At block 908, the apparatus determines a tap input is based, at least in part, on the second skin resistance measurement and the third skin resistance measurement. The determination may be similar as described regarding FIGS. 4A-4D, FIGS. 5A-5C, and FIG. 6.

As previously described, in some circumstances, a user may desire to perform a double tap input. In at least one example embodiment, the apparatus further receives information indicative of a fourth skin resistance measurement indicative of skin contact between the wear surface electrode sensor and the non-wear surface electrode sensor, and receives information indicative of a fifth skin resistance measurement indicative of absence of skin contact between the wear surface electrode sensor and the non-wear surface electrode sensor. In such an example, the apparatus may determine that the tap input is a double tap input based, at least in part, on the second skin resistance measurement, the third skin resistance measurement, the fourth skin resistance measurement, and the fifth skin resistance measurement.

In some circumstances, it may be desirable for the individual tap inputs of a double tap input to occur within a particular amount of time. For example, the apparatus may determine that two separate tap inputs if the tap inputs occur beyond a double tap threshold duration from each other, and may determine a double tap input if the tap inputs occur within a double tap threshold duration. In at least one example embodiment, the apparatus further determines that the fourth skin resistance measurement was received within a double tap threshold duration from receipt of the third skin resistance measurement. In such an example, the determination of the double tap input may be based, at least in part, on the determination that the fourth skin resistance measurement was received within a double tap threshold duration from receipt of the third skin resistance measurement.

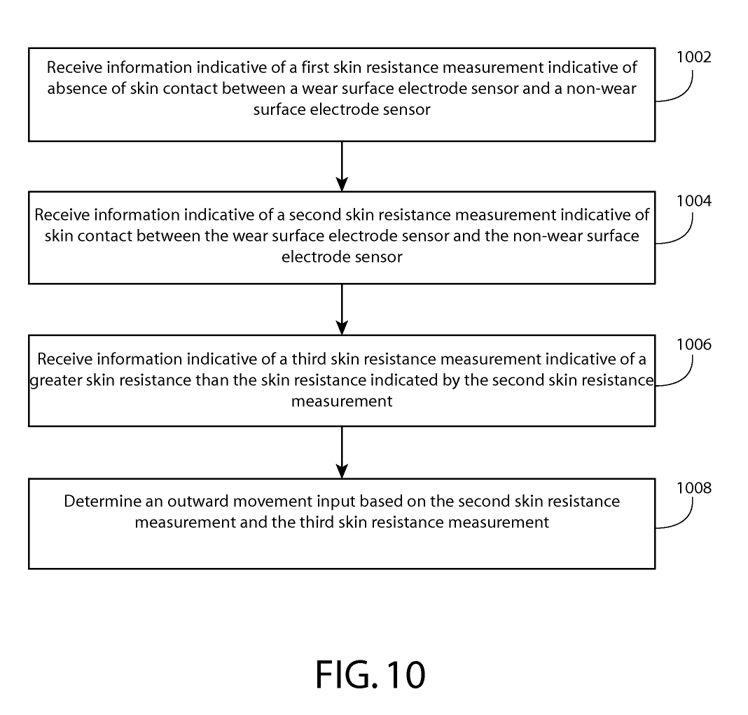

FIG. 10 is a flow diagram illustrating activities associated with determination of a user input based, at least in part, on skin resistance measurement according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As previously described, it may be desirable for a user to be able to perform an outward movement input. For example, it may be desirable for the apparatus to determine that skin resistance measurements are indicative of an outward movement input.

At block 1002, the apparatus receives information indicative of a first skin resistance measurement indicative of absence of skin contact between a wear surface electrode sensor and a non-wear surface electrode sensor, similarly as described regarding block 702 of FIG. 7. At block 1004, the apparatus receives information indicative of a second skin resistance measurement indicative of skin contact between the wear surface electrode sensor and the non-wear surface electrode sensor, similarly as described regarding block 704 of FIG. 7.

At block 1006, the apparatus receives information indicative of a third skin resistance measurement that is indicative of a greater skin resistance than the skin resistance indicated by the second skin resistance measurement. The third skin resistance measurement, and the greater skin resistance may be similar as described regarding FIG. 3 and FIGS. 4A-4D.

At block 1008, the apparatus determines an outward movement input based, at least in part, on the second skin resistance measurement and the third skin resistance measurement. The determination and the outward movement input may be similar as described regarding FIGS. 4A-4D, FIGS. 5A-5C, and FIG. 6.

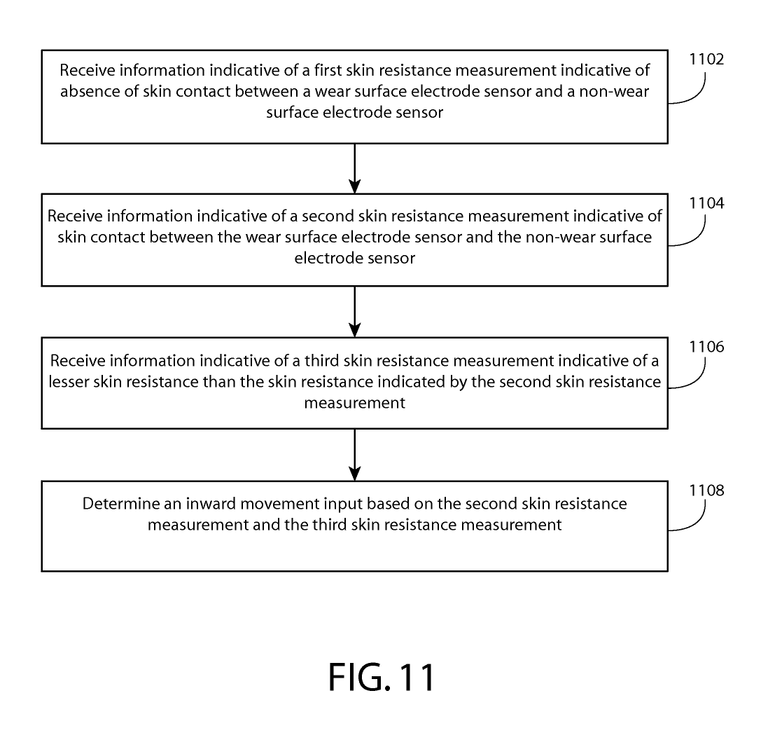

FIG. 11 is a flow diagram illustrating activities associated with determination of a user input based, at least in part, on skin resistance measurement according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As previously described, it may be desirable for a user to be able to perform an inward movement input. For example, it may be desirable for the apparatus to determine that skin resistance measurements are indicative of an inward movement input.

At block 1102, the apparatus receives information indicative of a first skin resistance measurement indicative of absence of skin contact between a wear surface electrode sensor and a non-wear surface electrode sensor, similarly as described regarding block 702 of FIG. 7. At block 1104, the apparatus receives information indicative of a second skin resistance measurement indicative of skin contact between the wear surface electrode sensor and the non-wear surface electrode sensor, similarly as described regarding block 704 of FIG. 7.

At block 1106, the apparatus receives information indicative of a third skin resistance measurement that is indicative of a lesser skin resistance than the skin resistance indicated by the second skin resistance measurement. The third skin resistance measurement, and the lesser skin resistance may be similar as described regarding FIG. 3 and FIGS. 4A-4D.

At block 1108, the apparatus determines an inward movement input based, at least in part, on the second skin resistance measurement and the third skin resistance measurement. The determination and the inward movement input may be similar as described regarding FIGS. 4A-4D, FIGS. 5A-5C, and FIG. 6.

FIG. 12 is a flow diagram illustrating activities associated with determination of a user input based, at least in part, on skin resistance measurement according to at least one example embodiment. In at least one example embodiment, there is a set of operations that corresponds with the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

In some circumstances, it may be desirable for the apparatus to be configured to differentiate between various types of user inputs.

At block 1202, the apparatus receives information indicative of a first skin resistance measurement indicative of absence of skin contact between a wear surface electrode sensor and a non-wear surface electrode sensor, similarly as described regarding block 702 of FIG. 7. At block 1204, the apparatus receives information indicative of a second skin resistance measurement indicative of skin contact between the wear surface electrode sensor and the non-wear surface electrode sensor, similarly as described regarding block 704 of FIG. 7.

At block 1206, the apparatus receives information indicative of a third skin resistance measurement indicative of skin resistance between the wear surface electrode sensor and the non-wear surface electrode sensor. The third skin resistance measurement may be similar as described regarding FIG. 3 and FIGS. 4A-4D. In at least one example embodiment, the third skin resistance measurement is different from the second skin resistance measurement.

At block 1208, the apparatus determines whether the third skin resistance measurement is indicative of absence of skin contact. The determination may be similar as described regarding FIG. 3. If the apparatus determines that the third skin resistance measurement is indicative of absence of skin contact, flow proceeds to block 1210. If the apparatus determines that the third skin resistance measurement is indicative of skin contact, flow proceeds to block 1212.

At block 1210, the apparatus determines a tap input. The determination and the tap input may be similar as described regarding FIGS. 4A-4D, FIGS. 5A-5C, FIG. 6, and FIG. 9. In this manner, the tap input may be determined based, at least in part, on the determination that the third skin resistance measurement is indicative of absence of skin contact.

At block 1212, the apparatus determines whether the third skin resistance measurement is indicative of a greater skin resistance than the skin resistance indicated by the second skin resistance measurement. The determination and the greater skin resistance may be similar as described regarding FIG. 3 and FIGS. 4A-4D. If the apparatus determines that the third skin resistance measurement is indicative of a lesser skin resistance than the skin resistance indicated by the second skin resistance measurement, flow proceeds to block 1214. If the apparatus determines that the third skin resistance measurement is indicative of a greater skin resistance than the skin resistance indicated by the second skin resistance measurement, flow proceeds to block 1216.

At block 1214, the apparatus determines an inward movement input. The determination and the inward movement input may be similar as described regarding FIGS. 4A-4D, FIGS. 5A-5C, and FIG. 6. In this manner, the determination of the inward movement input may be based, at least in part, on the determination that the third skin resistance measurement is indicative of a lesser skin resistance than the skin resistance indicated by the second skin resistance measurement.

At block 1216, the apparatus determines an outward movement input. The determination and the outward movement input may be similar as described regarding FIGS. 4A-4D, FIGS. 5A-5C, and FIG. 6. In this manner, the determination of the outward movement input may be based, at least in part, on the determination that the third skin resistance measurement is indicative of a greater skin resistance than the skin resistance indicated by the second skin resistance measurement.

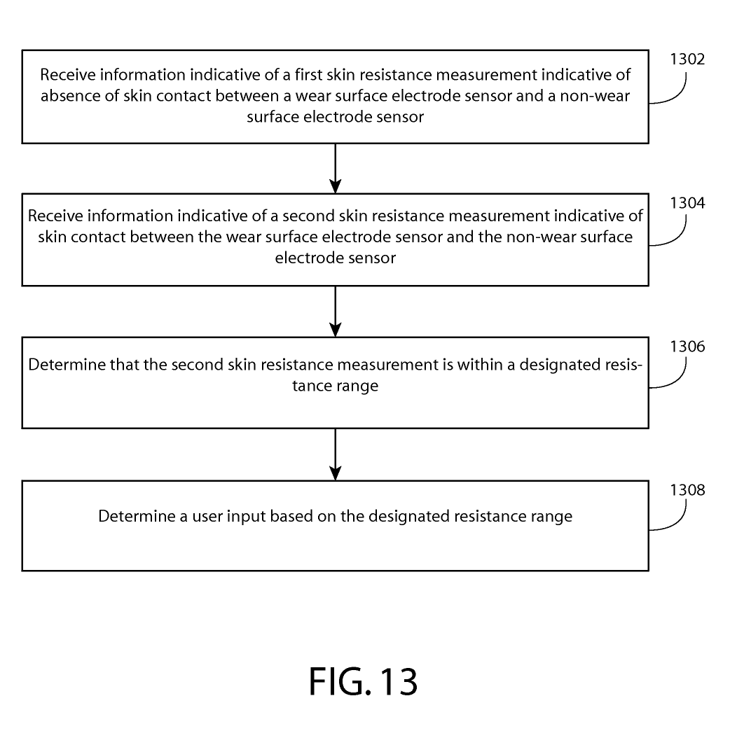

FIG. 13 is a flow diagram illustrating activities associated with determination of a user input based, at least in part, on skin resistance measurement according to at least one example embodiment. In at least one example embodiment, there is a set of operations that corresponds with the activities of FIG. 13. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 13.

As previously described, it may be desirable to determine whether a skin resistance measurement corresponds with a particular distance from the apparatus and/or how many fingers are associated with the skin contact of the skin resistance measurement. In this manner, it may be desirable to determine whether a skin resistance measurement corresponds with a designated resistance range.

At block 1302, the apparatus receives information indicative of a first skin resistance measurement indicative of absence of skin contact between a wear surface electrode sensor and a non-wear surface electrode sensor, similarly as described regarding block 702 of FIG. 7. At block 1304, the apparatus receives information indicative of a second skin resistance measurement indicative of skin contact between the wear surface electrode sensor and the non-wear surface electrode sensor, similarly as described regarding block 704 of FIG. 7.

At block 1306, the apparatus determines that the second skin resistance measurement is within a designated resistance range. The determination and the designated resistance range may be similar as described regarding FIGS. 5A-5C and FIG. 6.

At block 1308, the apparatus determines a user input based, at least in part, on the designated resistance range. The determination and the user input may be similar as described regarding FIGS. 5A-5C and FIG. 6.

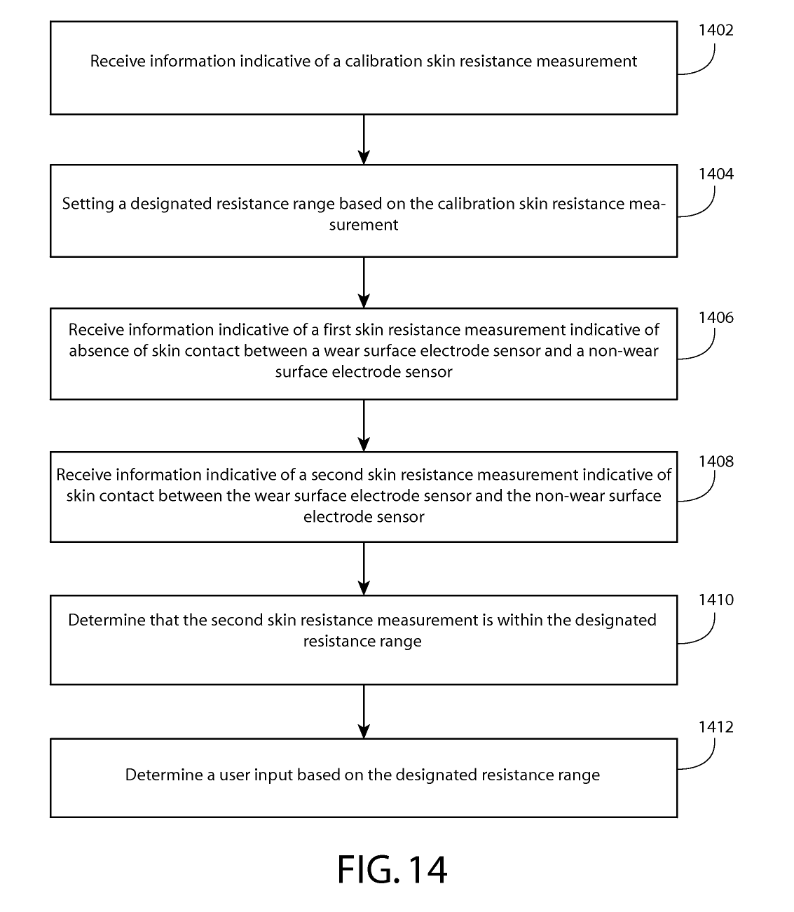

FIG. 14 is a flow diagram illustrating activities associated with determination of a user input based, at least in part, on skin resistance measurement according to at least one example embodiment. In at least one example embodiment, there is a set of operations that corresponds with the activities of FIG. 14. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 14.

In some circumstances, skin resistance of a particular part of skin may vary in relation to the physiological circumstances of the user. For example, the moisture level of the skin may cause the skin resistance to vary, the tension of the skin may cause the skin resistance to vary, and/or the like. In such circumstances, it may be desirable to base a designated resistance range, at least in part, on a calibration skin resistance measurement. In at least one example embodiment, a skin resistance calibration measurement is skin resistance measurement that provides a baseline measurement for the apparatus to utilize in determination of one or more designated resistance ranges.

As previously described, in at least one example embodiment, the designated resistance range is a range of skin resistance measurements that is indicative of a finger contacting the skin at a designated distance. In such an example, the calibration skin resistance measurement may be associated with the designated distance. For example, there may be a calibration skin resistance measurement associated with distance 511 of FIG. 5A. In this manner, the apparatus may set the skin resistance range associated with the designated distance based, at least in part, on the skin resistance measurement of the calibration skin resistance measurement.

As previously described, in at least one example embodiment, the designated resistance range is a range of skin resistance measurements that is indicative of a particular number of fingers contacting the skin. In such an example, the calibration skin resistance measurement may be associated with the particular number of fingers. For example, there may be a calibration skin resistance measurement associated with the dual finger contact of FIG. 6. In this manner, the apparatus may set the skin resistance range associated with the particular number of fingers based, at least in part, on the skin resistance measurement of the calibration skin resistance measurement.

In at least one example embodiment, the apparatus causes display of a calibration input request. For example, the apparatus may display information that allows the user to understand that a subsequent user input may be interpreted as a skin resistance calibration measurement. In at least one example embodiment, the calibration input request may identify an aspect of the user input to be associated with the designated skin resistance range to be set by the skin resistance calibration input. For example, the calibration input request may identify a particular number of fingers, a designated distance, and/or the like.

At block 1402, the apparatus receives information indicative of a calibration skin resistance measurement.

At block 1404, the apparatus sets the designated resistance range based, at least in part, on the calibration skin resistance measurement. The setting of the designated distance range may be based, at least in part, on a tolerance range that surrounds a value indicated by the skin resistance measurement. In at least one example embodiment, the tolerance range is a range of skin resistance measurements that may be interpreted as being within the designated skin resistance range even though such skin resistance measurements may fail to directly correspond with the calibration skin resistance measurement.

At block 1406, the apparatus receives information indicative of a first skin resistance measurement indicative of absence of skin contact between a wear surface electrode sensor and a non-wear surface electrode sensor, similarly as described regarding block 702 of FIG. 7. At block 1408, the apparatus receives information indicative of a second skin resistance measurement indicative of skin contact between the wear surface electrode sensor and the non-wear surface electrode sensor, similarly as described regarding block 704 of FIG. 7. At block 1410, the apparatus determines that the second skin resistance measurement is within the designated resistance range, similarly as described regarding block 1306 of FIG. 13. At block 1412, the apparatus determines a user input based, at least in part, on the designated resistance range similarly as described regarding block 1308 of FIG. 13.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 1402 and 1404 of FIG. 14 may be performed after block 1406 of FIG. 14. Furthermore, if desired, one or more of the above-described functions may be optional or may be combined. For example, block 1306 of FIG. 13 may be optional and/or combined with block 1308 of FIG. 13.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. A wearable apparatus, comprising:
at least one processor;
at least one memory including computer program code, the memory and the computer program code configured to, working with the processor, cause the apparatus to perform at least the following:
receipt of information indicative of a first skin resistance measurement indicative of absence of skin contact between a wear surface electrode sensor and a non-wear surface electrode sensor;
receipt of information indicative of a second skin resistance measurement indicative of skin contact between the wear surface electrode sensor and the non-wear surface electrode sensor; and
determination of a user input based, at least in part, on the second skin resistance measurement.

2. The apparatus of claim 1, wherein a wear surface of the wearable apparatus is a surface that is configured to be contacted with skin of a user as a result of the wearable apparatus being worn by the user.

3. The apparatus of claim 1, wherein a non-wear surface of the wearable apparatus is a surface that is configured to avoid being contacted with skin of the user as a result of the wearable apparatus being worn by the user.

4. The apparatus of claim 1, wherein the memory includes computer program code configured to, working with the processor, cause the apparatus to perform an operation based, at least in part, on the user input.

5. The apparatus of claim 1, wherein the memory includes computer program code configured to, working with the processor, cause the apparatus to perform receipt of information indicative of a third skin resistance measurement that is indicative of absence of skin contact between a wear surface electrode sensor and a non-wear surface electrode sensor, wherein the user input is a tap input, and the determination of the tap input is further based, at least in part, on the third skin resistance measurement.

6. The apparatus of claim 1, wherein the memory includes computer program code configured to, working with the processor, cause the apparatus to perform receipt of information indicative of a third skin resistance measurement that is indicative of a greater skin resistance than the skin resistance indicated by the second skin resistance measurement, wherein the user input is an outward movement input, and the determination of the outward movement input is further based, at least in part, on the third skin resistance measurement.

7. The apparatus of claim 1, wherein the memory includes computer program code configured to, working with the processor, cause the apparatus to perform receipt of information indicative of a third skin resistance measurement that is indicative of a lesser skin resistance than the skin resistance indicated by the second skin resistance measurement, wherein the user input is an inward movement input, and the determination of the inward movement input is further based, at least in part, on the third skin resistance measurement.

8. The apparatus of claim 1, wherein the memory includes computer program code configured to, working with the processor, cause the apparatus to perform determination that the second skin resistance measurement is within a designated resistance range, wherein the determination of the user input is based, at least in part, on the determination that the second skin resistance measurement is within the designated resistance range.

9. The apparatus of claim 8, wherein the memory includes computer program code configured to, working with the processor, cause the apparatus to perform:
receipt of information indicative of a calibration skin resistance measurement; and
setting the designated resistance range based, at least in part, on the calibration skin resistance measurement.

10. A method comprising:
receiving, by a wearable apparatus, information indicative of a first skin resistance measurement indicative of absence of skin contact between a wear surface electrode sensor and a non-wear surface electrode sensor;
receiving information indicative of a second skin resistance measurement indicative of skin contact between the wear surface electrode sensor and the non-wear surface electrode sensor; and
determining a user input based, at least in part, on the second skin resistance measurement.

11. The method of claim 10, wherein a wear surface of the wearable apparatus is a surface that is configured to be contacted with skin of a user as a result of the wearable apparatus being worn by the user.

12. The method of claim 10, wherein a non-wear surface of the wearable apparatus is a surface that is configured to avoid being contacted with skin of the user as a result of the wearable apparatus being worn by the user.

13. The method of claim 10, further comprising performing an operation based, at least in part, on the user input.

14. The method of claim 10, further comprising receiving information indicative of a third skin resistance measurement that is indicative of absence of skin contact between a wear surface electrode sensor and a non-wear surface electrode sensor, wherein the user input is a tap input, and the determination of the tap input is further based, at least in part, on the third skin resistance measurement.

15. The method of claim 10, further comprising receiving information indicative of a third skin resistance measurement that is indicative of a greater skin resistance than the skin resistance indicated by the second skin resistance measurement, wherein the user input is an outward movement input, and the determination of the outward movement input is further based, at least in part, on the third skin resistance measurement.

16. The method of claim 10, further comprising receiving information indicative of a third skin resistance measurement that is indicative of a lesser skin resistance than the skin resistance indicated by the second skin resistance measurement, wherein the user input is an inward movement input, and the determination of the inward movement input is further based, at least in part, on the third skin resistance measurement.

17. At least one computer-readable medium encoded with instructions that, when executed by a processor, perform:
receipt, by a wearable apparatus, of information indicative of a first skin resistance measurement indicative of absence of skin contact between a wear surface electrode sensor and a non-wear surface electrode sensor;
receipt of information indicative of a second skin resistance measurement indicative of skin contact between the wear surface electrode sensor and the non-wear surface electrode sensor; and
determination of a user input based, at least in part, on the second skin resistance measurement.

18. The medium of claim 17, wherein a wear surface of the wearable apparatus is a surface that is configured to be contacted with skin of a user as a result of the wearable apparatus being worn by the user.

19. The medium of claim 17, wherein a non-wear surface of the wearable apparatus is a surface that is configured to avoid being contacted with skin of the user as a result of the wearable apparatus being worn by the user.

20. The medium of claim 17, further encoded with instructions that, when executed by a processor, perform an operation based, at least in part, on the user input.
